(19) United States
(12) Patent Application Publication
(10) Pub. No.: US 2016/0050649 A1
(43) Pub. Date: Feb. 18, 2016

(54) METHOD AND APPARATUS FOR MANAGING RESOURCE IN SMALL CELL ENVIRONMENT

(71) Applicant: ELECTRONICS AND TELECOMMUNICATIONS RESEARCH INSTITUTE, Daejeon (KR)

(72) Inventors: Soon Gi PARK, Daejeon (KR); Dong Seung KWON, Daejeon (KR); Yeon Seung SHIN, Daejeon (KR); Byung Han RYU, Daejeon (KR)

(73) Assignee: ELECTRONICS AND TELECOMMUNICATIONS RESEARCH INSTITUTE, Daejeon (KR)

(21) Appl. No.: 14/829,267

(22) Filed: Aug. 18, 2015

(30) Foreign Application Priority Data
Aug. 18, 2014 (KR) 10-2014-0107169

(51) Int. Cl. H04W 72/04; H04L 12/721

(52) U.S. Cl. CPC H04W 72/042; H04L 45/70; H04W 88/02

(57) ABSTRACT

Disclosed are a method and an apparatus for managing a resource in a small cell environment. The method for managing a resource in a small cell environment by a macro base station for controlling connection between user equipment (UE) and a gateway (GW), includes: configuring at least one packet path between the GW and the UE through a bearer of the macro base station; determining whether to add at least one small base station in the macro base station to the at least one packet path according to signal strength of the at least one small base station from the UE; and changing the at least one packet path using a bearer of a small base station based on the result.

Priority to Korean patent application number 2014-0107169 filed on Aug. 18, 2014, the entire disclosure of which is incorporated by reference herein, is claimed.

### BACKGROUND OF THE INVENTION

(a) Technical Field

The present invention relates to wireless communication and more particularly to a method and an apparatus for managing a resource in a macro based small cell environment.

(b) Background Art

A multiple component carrier system means a wireless communication system capable of supporting carrier aggregation. The carrier aggregation is a technology for efficiently using a small piece band and allows a one base station to freely use the carrier aggregation according to a situation on a great band by binding a plurality of physical continuous or non-continuous bands at a frequency domain. The multiple component carrier system may refer to a multiple carrier system. The multiple component carrier system supports a plurality of component carriers (CCs) which are identified at a frequency domain. The component carrier includes an uplink component carrier used in uplink and a downlink component carrier used in downlink. The uplink component carrier is combined with the downlink component carrier and may be serve as one logic serving cell. Alternatively, only the downlink component carrier may be used as one logic serving cell.

There is a demand of special great communication at a specific zone such as a hotspot inside a cell. A receiving sensitivity of a radio wave may be deteriorated at a specific zone such as a cell edge or a coverage hole. With the development of a wireless communication technology, in order to allow communication at a zone such as a hotspot, a cell edge, and a coverage hole, small cells, for example, a Pico Cell, a Femto Cell, a Micro Cell, a remote radio head (RRH), a relay, and a repeater are installed in a macro cell together. Such a network refers to a heterogeneous network (HetNet). In the heterogeneous network environment, a macro cell refers to a large cell with relatively large coverage. A small cell such as the Femto Cell and the Pico cell is a cell with small coverage. In the heterogeneous network environment, coverage overlapping occurs between a plurality of macro cells and small cells.

A dual connectivity scheme is introduced in the heterogeneous network environment as one cell planning scheme for distributing an excessive load or a load requiring a specific QoS in a small cell without a handover process, and efficiently transmitting data. A UE may connect with at least two different base stations (a macro base station including a macro cell and a small base station including a small cell) in a wireless channel through different frequency bands to transmit/receive a service.

There are three methods of coping with explosion of traffic in a current mobile communication system (particularly, Long Term Evolution (hereinafter referred to as ‘LTE’) or LTE-Advanced (hereinafter referred to as ‘LTE-A’). A first method is a method of increasing spectral efficiency. A second method is a method of further increasing a use frequency band. A third method is a method of densifying a small cell. Among them, in a case of densifying the small cell, since a current resource management method of a mobile communication system is based on a homogeneous macro cell environment, the method is not optimized with a small cell environment. In other words, since the resource management method based on the macro cell environment is optimized with the macro cell, the resource management method is not suited to appearance of a user equipment (UE) based on the dual connectivity scheme, an independent small cell environment, and the heterogeneous network environment including a macro/small cell. Therefore, there is a need for a resource management method which is optimized with a small cell environment.

### SUMMARY OF THE DISCLOSURE

The present invention provides a method and an apparatus for managing a resource in a small cell environment.

The present invention further provides a method and an apparatus for managing a resource under macro-driven.

The present invention further provides a wireless bearer in a small cell environment.

The present invention further provides a method and an apparatus for a downlink packet in a small cell environment.

In accordance with an aspect of the present invention, there is provided a method for managing a resource in a small cell environment by a macro base station for controlling connection between user equipment (UE) and a gateway (GW), the method including: configuring at least one packet path between the GW and the UE through a bearer of the macro base station; determining whether to add at least one small base station in the macro base station to the at least one packet path according to signal strength of the at least one small base station from the UE; and changing the at least one packet path using a bearer of a small base station based on the result.

An E-RAB of an EPS bearer defined between the GW and the UE may include an E-RAB 0 and an E-RAB 1, and, the configuring of the at least one packet path may include:

configuring a first packet path by connecting a first bearer of the macro base station to the E-RAB 0; and configuring a second packet path by connecting a second bearer of the macro base station to the E-RAB 1.

The determining whether to add at least one small base station in the macro base station includes: determining whether to add the first small base station to the second packet path using signal strength of a first small base station among at least one small base station included in the macro base station; and transferring a small cell addition message indicating that the first small base station is added to the second packet path.

The changing of the at least one packet path may include: transferring configuration information of the first small base station to the UE; receiving a RRC Connection Reconfiguration Complete message indicating that connection of a bearer of the first small base station is terminated instead of a second bearer of the macro base station in the E-RAB 1 from the UE; and terminating change of the second packet path by requesting to change connection of a S1-U of the E-RAB 1 from the macro base station to the first small base station to the GW.

The method may include further include: determining deletion of the bearer of the first small base station connected to the E-RAB 1 using the signal strength of the first small base station; deleting the bearer of the first small base station connected to the E-RAB 1 and requesting to connect a second bearer of the macro base station to the UE; and configuring the second packet path to before change by requesting to change the connection of the S1-U of the E-RAB 1 from the first small base station to the macro base station.

The determining whether to add at least one small base station may include: determining whether to add the first small base station to the second packet path using signal strength of a first small base station among at least one small base station included in a cell of the macro base station; connecting the second bearer of the macro base station to the bearer of the first small base station through a Xn-U in order to configure the bearer of the first small base station in the E-RAB 1; and releasing the connection of the second bearer of the macro base station from the E-RAB 1.

The changing of the at least one packet path may include: changing connection of the S1-U of the E-RAB 1 from the bearer of the macro base station to the bearer of the first small base station.

The determining whether to add at least one small base station may include: determining whether to add the first small base station to the second packet path using signal strength of a first small base station among at least one small base station included in a cell of the macro base station; connecting the second bearer of the small base station to the bearer of the first small base station through a Xn-U in order to configure the bearer of the first small base station in the E-RAB 1; and maintaining connection of the second bearer of the macro base station to the E-RAB 1.

The changing of the at least one packet path may include: ensuring a double path by adding connection with the first small base station through a Xn-U in a state that connection of the second bearer of the macro base station in the S1-U of the E-RAB 1 maintains.

The method may further include one of simultaneously transmitting a same packet through the double path; and selecting a path having excellent transmission quality from the double path to transmit a path through the selected path.

In accordance with an aspect of the present invention, there is provided a method for managing a resource in a small cell environment by a macro base station for controlling connection between user equipment (UE) and a gateway (GW), the method including: configuring at least one packet path by connecting the GW to the UE through a bearer of the macro base station; additionally configuring connection of a first small base station among at least two small base stations in the at least one packet path; determining whether change connection with the first small base station to connection of a second small base station based on a result of comparing signal strength of a second small base station to be replaced with the first small base station with signal strength of the first small base station; and changing the at least one packet path by connecting the second small base station to the at least one packet path according to the determination.

An E-RAB of an EPS bearer defined between the GW and the UE may include an E-RAB 0 and an E-RAB 1, and, the configuring of the at least one packet path may include: configuring a first packet path by connecting a first bearer of the macro base station to the E-RAB 0; and configuring a second packet path by connecting a second bearer of the macro base station to the E-RAB 1.

The determining whether change connection with the first small base station may include: receiving a result of comparing signal strength of the first small base station with signal strength of the second base station; determining whether to changing the first small base station to the second small base station based on the comparison result; and transferring a message indicating that the second small base station is added to the second packet path to the small base station.

The changing the at least one packet path may include: deleting configuration information of the first small base station and transferring configuration information of the second small base station to the UE; receiving a message indicating that connection of a bearer of the second small base station is terminated instead of a bearer of the small base station in the E-RAB 1 from the UE; and transferring a deletion request message to the first small base station to delete bearer configuration information of the first small base station; and receiving a deletion termination message from the first small base station.

The changing the at least one packet path may include: terminating change of the second packet path by connecting the second small base station instead of the first small base station in the second packet path.

In accordance with an aspect of the present invention, there is provided a method for managing a resource in a small cell environment including at least one small base station included in a cell of a macro base station for controlling connection between user equipment (UE) and a gateway (GW), the method including: configuring a first packet path by connecting a first bearer of the macro base station to an E-RAB 0 defined between the UE and the GW; configuring a second packet path by connecting a second bearer of the macro base station to an E-RAB 1 defined between the UE and the GW; requesting to connect the bearer of the first small base station to the E-RAB 1 in order to add a first small base station among the at least one small base station and changing the second packet path by connecting the bearer of the first small base station to the E-RAB 1.

The requesting to connect the bearer of the first small base station include: transferring a Small cell Addition message to the first small base station through a Xn-C; and receiving a Small cell Addition ACK message from the first small base station through the Xn-C when connection of the bearer of the first small base station to the E-RAB 1 is terminated.

The requesting to connect the bearer of the first small base station may include: connecting the bearer of the first small base station to the E-RAB 1 through a Xn-C; and generating the Xn-C to connect the macro base station to the first small base station.

The changing the at least one packet path may include: changing the second packet path by connecting the bearer of the first small base station including a RLC, a MAC, and a PHY through the a Xn-U after connecting the second bearer of the macro base station including a GTP and a PDCP to the E-RAB 1.

The requesting configuration of the bearer may include: connecting the bearer of the first small base station to the E-RAB 1 through a Xn-C; maintaining connection of the second bearer of the macro base station to the E-RAB 1; and generating a Xn-U to connect the macro base station to the small base station.

According to the present invention, a wireless resource may be efficiently managed in a new mobile communication system environment. A resource provided from a macro-driven based small cell environment may be efficiently used.

Further, the present invention may provide a method of managing a resource optimized with a small cell under control of a macro cell in a mobile communication system environment including appearance of a UE based on the dual connectivity scheme, an independent small cell environment, and a mobile communication network environment including a macro/small cell through detailed message exchanged between a macro base station and a small cell base station and data transmission to the UE for dual connection configuration, release, and exchange for double connectivity of a macro cell and a small cell in a heterogeneous network environment.

### BRIEF DESCRIPTION OF THE DRAWINGS

FIG. 1 is a diagram illustrating a wireless communication system according to an embodiment of the present invention;

FIG. 2 is a diagram illustrating an example of a small cell operation structure according to an embodiment of the present invention;

FIG. 3 is a diagram illustrating another example of a small cell operation structure according to an embodiment of the present invention;

FIG. 4 is a diagram illustrating an example of a framework for a small cell operation structure according to an embodiment of the present invention;

FIG. 5 is a diagram illustrating an example of a bearer service structure according to an embodiment of the present invention;

FIG. 6 is a diagram illustrating an example of a bearer connection scheme according to an embodiment of the present invention;

FIG. 7 is a diagram illustrating another example of a bearer connection scheme according to an embodiment of the present invention;

FIG. 8 is a diagram illustrating another example of a bearer connection scheme according to an embodiment of the present invention;

FIG. 9 is a diagram illustrating an example of transmitting a downlink packet according to an embodiment of the present invention;

FIG. 10 is a diagram illustrating another example of transmitting a downlink packet according to an embodiment of the present invention;

FIG. 11 is a diagram illustrating another example of transmitting a downlink packet according to an embodiment of the present invention;

FIGS. 12 and 13 are flowcharts illustrating examples of a small cell operation process according to an embodiment of the present invention, respectively;

FIGS. 14 and 15 are flowcharts illustrating other examples of a small cell operation process according to an embodiment of the present invention, respectively;

FIGS. 16 and 17 are flowcharts illustrating other examples of a small cell operation process according to an embodiment of the present invention, respectively; and

FIGS. 18 and 19 are flowcharts illustrating other examples of a small cell operation process according to an embodiment of the present invention, respectively.

### DETAILED DESCRIPTION

The above objects, features, and advantages can be more clearly comprehended through the following description in relation to accompanying drawings. Accordingly, those skilled in the art can easily realize the present inventive concept. In the following description, if detailed description about well-known functions or configurations may make the subject matter of the disclosure unclear, the detailed description will be omitted.

Further, the following description will be made while focusing on a wireless communication network. An operation achieved by a wireless communication network may be performed during a process where a system (e.g., base station) for controlling a corresponding wireless communication network controls a network and transmits data or by a UE combined with a corresponding wireless network.

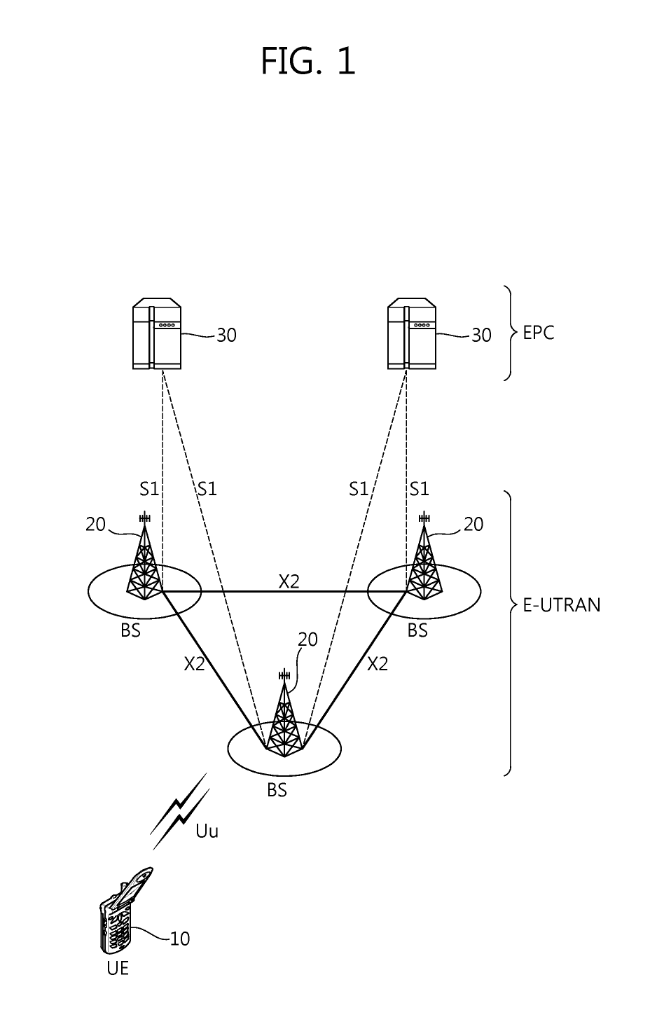

FIG. 1 is a diagram illustrating a wireless communication system according to an embodiment of the present invention. The above wireless communication system may be a network structure of an Evolved-Universal Mobile Telecommunications System (E-UMTS). The E-UMTS may include LTE (Long Term Evolution) or LTE-A (advanced) system.

There is no limitation on a multiple access scheme applied to the wireless communication system. Various multiple access schemes such as CDMA (Code Division Multiple Access), TDMA (Time Division Multiple Access), FDMA (Frequency Division Multiple Access), OFDMA(Orthogonal Frequency Division Multiple Access), SC-FDMA (Single Carrier-FDMA), OFDM-FDMA, OFDM-TDMA, OFDM-CDMA may be used.

Referring to FIG. 1, the E-UTRAN includes a base station (BS) 20 to provide a control plane and a user plane to user equipment (UE) 10. The user plane is a protocol stack for transmitting user data. The control plane is a protocol stack for transmitting a control signal. The UE 10 may be fixed or mobile and may refer to other terms such as a MS (Mobile station), a AMS (Advanced MS), a UT (User Terminal), a SS (Subscriber Station), and a Wireless Device.

In general, the base station 20 means a station communicating with the UE 10. The base station 20 may refer to other terms such as an eNodeB (evolved-NodeB), a BTS (Base Transceiver System), an Access Point, a femto-eNB, a pico-eNB, a Home eNB, and a relay. The base station 20 may provide at least one cell to the UE. The cell may be a geometric zone to which the base station 20 provides a communication service.

The base stations 20 may be connected to each other through an X2 interface. The base station 20 is connected to an EPC (Evolved Packet Core) 30 through an S1 interface, in detail, to an MME (Mobility Management Entity) through an S1-MME, and to an S-GW (Serving Gateway) through an S1-U. The S1 interface supports many-to-many-relation between the base station 20 and an MME/S-GW 30.

The EPC 30 includes a MME, a S-GW, and a P-GW (Packet Data Network-Gateway). The MME includes access information of the UE 10 and information on capacity of the UE 10. The S-GW is a gateway to include an E-UTRAN as a termination point. The P-GW is a gateway to include a PDN (Packet Data Network) as a termination point.

A combination of the E-UTRAN and the EPC(30) may refer to an EPS (Evoled Packet System). A traffic flow from a wireless link accessing the base station 20 to a PDN connecting with a service entity is all operated based on an IP (Internet Protocol).

Wireless interface between the UE and the base station refers to Uu interface. Layers of a Radio Interface Protocol between the UE and the network may be classified into a L1 (first layer), a L2 (second layer), and a L3 (third layer) based on three lower layers of an Open System Interconnection (OSI) reference model which is widely known in a communication system. Among them, physical layers included in the first layer provide an Information Transfer Service using a physical channel. A RRC (Radio Resource Control) layer located in the third layer serves to control a wireless resource between the UE and a network. To this end, the RRC layer exchanges a RRC message between the UE and the base station.

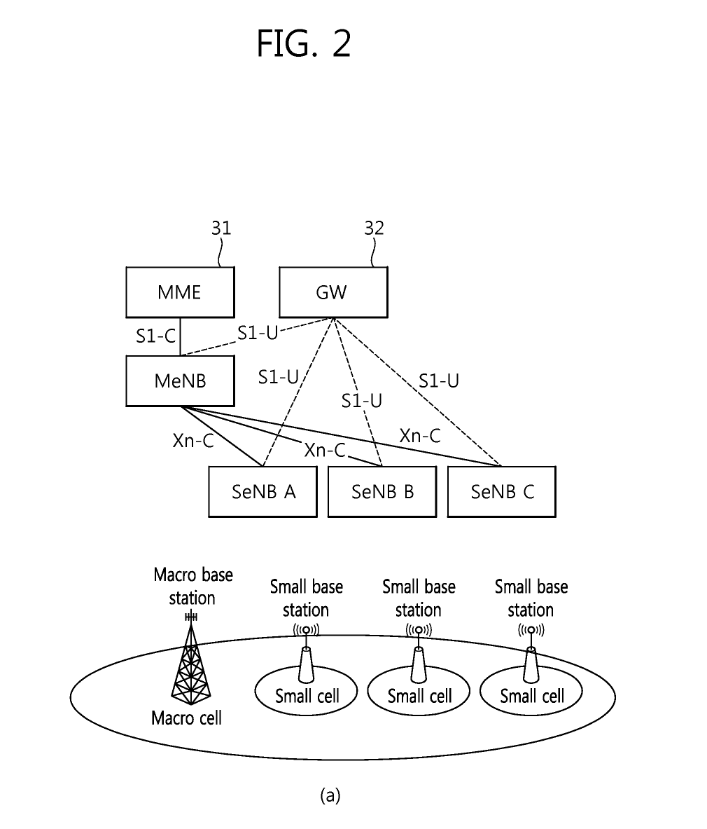

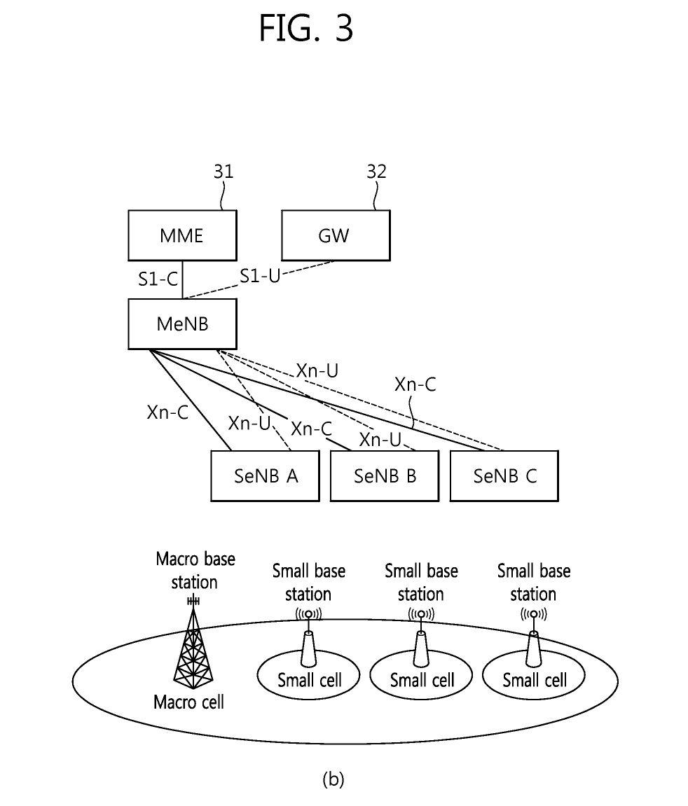

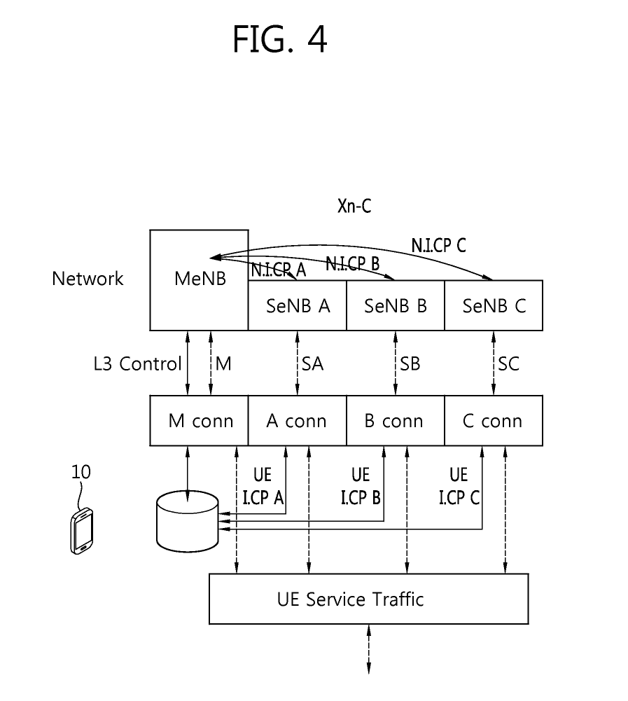

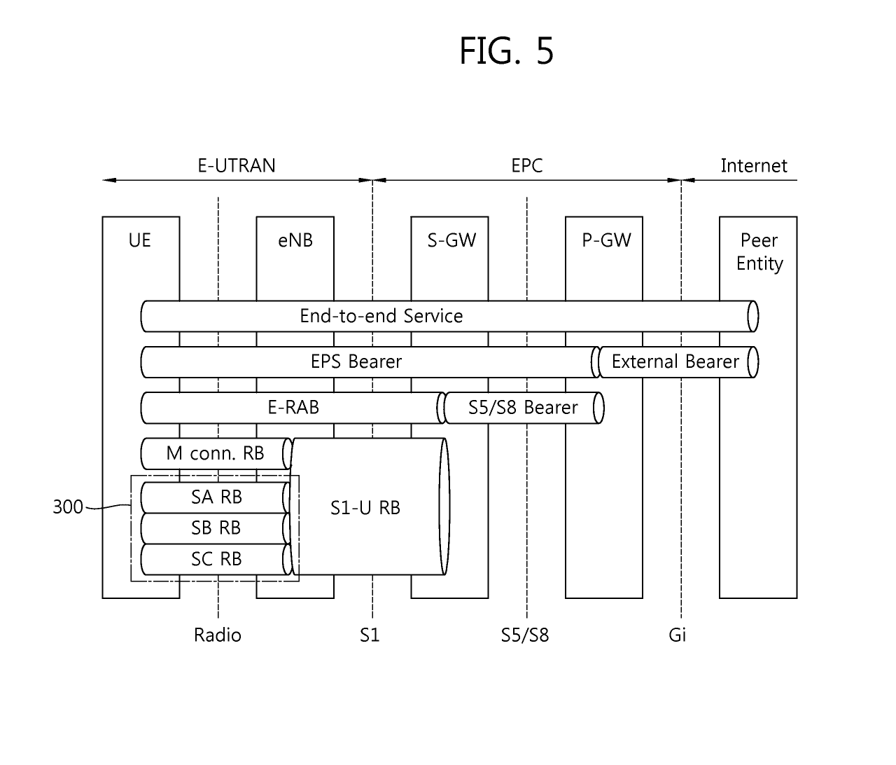

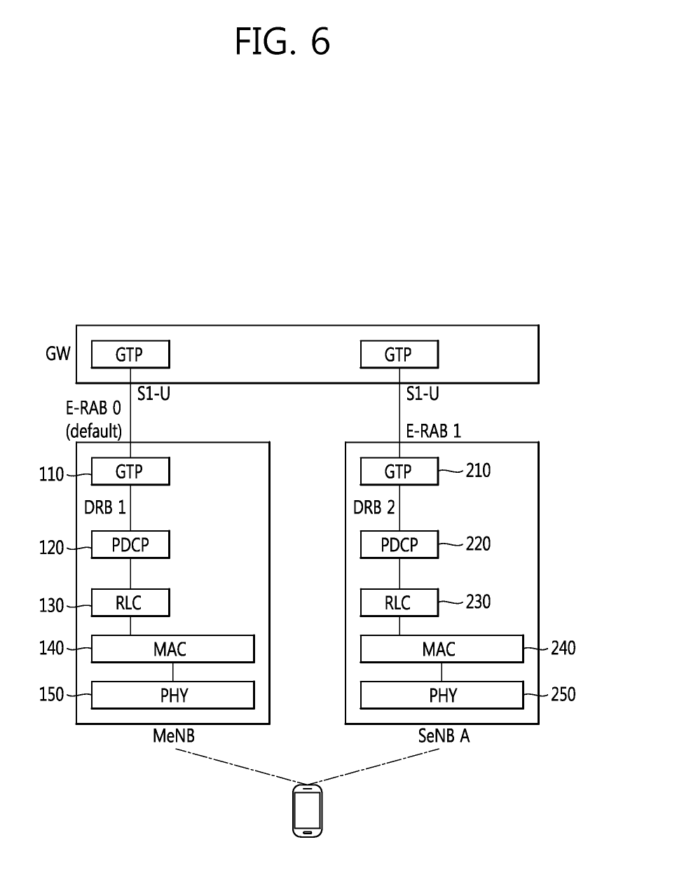

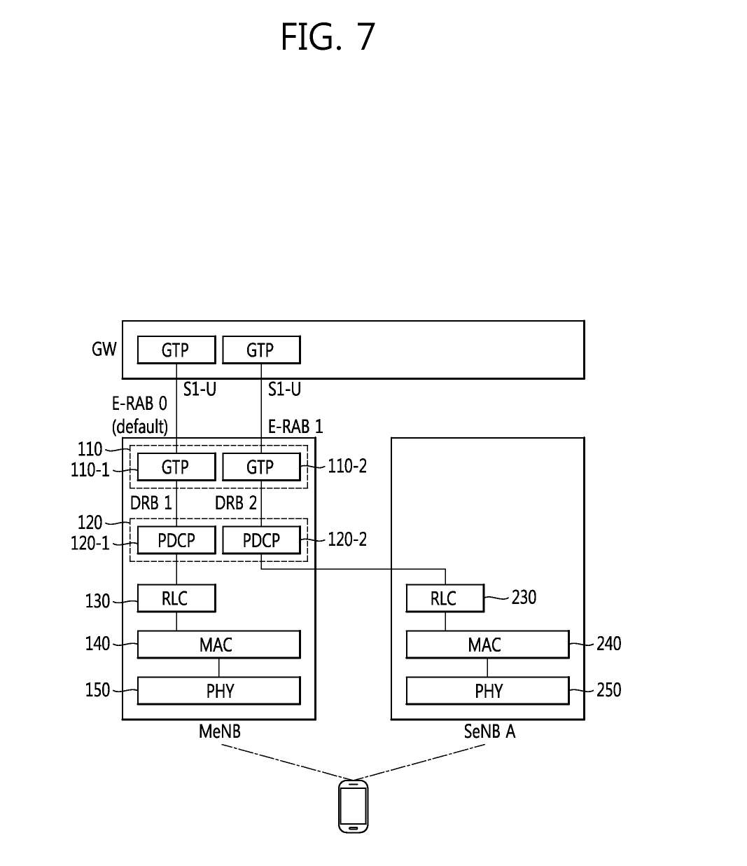

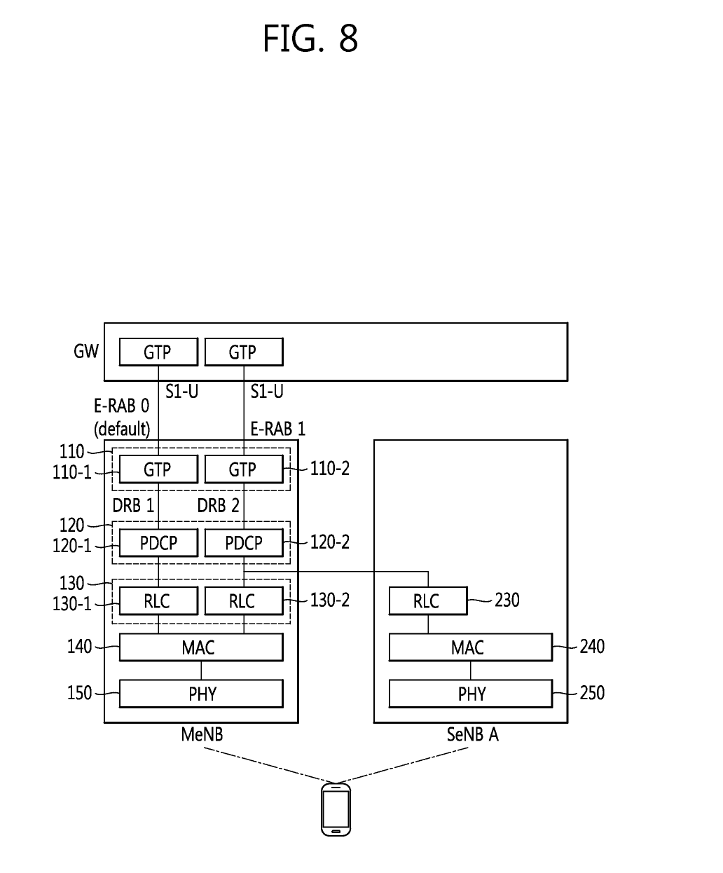

FIG. 2 is a diagram illustrating an example of a small cell operation structure according to an embodiment of the present invention. FIG. 3 is a diagram illustrating another example of a small cell operation structure according to an embodiment of the present invention. FIG. 4 is a diagram illustrating an example of a framework for a small cell operation structure according to an embodiment of the present invention. FIG. 5 is a diagram illustrating an example of a bearer service structure according to an embodiment of the present invention. FIG. 6 is a diagram illustrating an example of a bearer connection scheme according to an embodiment of the present invention. FIG. 7 is a diagram illustrating another example of a bearer connection scheme according to an embodiment of the present invention. FIG. 8 is a diagram illustrating another example of a bearer connection scheme according to an embodiment of the present invention.

A wireless communication system according to the present invention is operated at a heterogeneous Network: environment HetNet. In the heterogeneous network environment, a macro cell refers to a large cell with relatively large coverage. A small cell is a cell with small coverage. The small cells, a Pico Cell, a Femto Cell, a Micro Cell, a remote radio head (RRH), a relay, and a repeater are installed in the macro cell together.

The macro base station MeNB is included in at least one macro cell. The macro base station MeNB may refer to a master base station or a primary base station. The small base station SeNB is included in at least one small cell in the macro cell. The small base station SeNB may refer to an assisting base station or a secondary base station.

In this way, in order to cope with data explosion of the UE in a wireless communication system operating in a heterogeneous network environment, a method of developing the small cell includes a method of independently developing a macro cell and a small cell and a method of operating the small cell under macro-driven. A latter method of the present invention will be described.

Two methods of operating the small cell under macro-driven according to the present invention are illustrated in FIGS. 2 and 3.

Referring to FIG. 2, in an operation structure (a), the macro base station MeNB controls small base stations SeNB A, SeNB B, and SeNB C included in a macro cell of the macro base station by Xn-C interface (hereinafter, referred to as “Xn-C”). The macro base station MeNB is connected to an MME 31 through an S1-C interface (hereinafter referred to as “S1-C”), and is connected to a GW 32 through an S1-U interface (hereinafter referred to as “S1-U”). Upon traffic transmission/reception, the GW 32 transmits/receives traffic through direct connection with the small base stations SeNB A, SeNB B, and SeNB C through an S1-U.

Meanwhile, referring to FIG. 3, in an operation structure (b), the macro base station MeNB controls small base stations SeNB A, SeNB B, and SeNB C included in a macro cell of the macro base station by the Xn-C. The macro base station MeNB is connected to the MME 31 through the S1-C, and is connected to a GW 32 through an S1-U. Upon traffic transmission/reception, unlike in the operation structure (a), a GW 32 is connected to the macro base station MeNB through a S1-U. The small base stations SeNB A, SeNB B, and SeNB transmit/receive traffic through Xn-U interface (hereinafter referred to as “Xn-U”) with the macro base station MeNB.

In the operation structures (a, b), as shown in FIG. 4, the macro base station MeNB controls the small base stations SeNB A, SeNB B, and SeNB C included in a macro cell of the macro base station through the Xn-C. In this case, a Network Internal Control Path (N.I.CP) is formed. If downlink traffic to the UE 10 is provided to a macro base station MeNB in a bearer form in an EPC, the downlink traffic may be transmitted to the UE through at least one of respective cells of a MeNB, a SeNB A, a SeNB B, and a SeNB C under control of the macro base station MeNB. Further, uplink traffic is transmitted through at least one of respective cells of the MeNB, the SeNB A, the SeNB B, and the SeNB C according to a User Equipment Internal Path (UE.I.CP). The uplink traffic may be transmitted to an upper stage through the S1-U. That is, the MeNB, the SeNB A, the SeNB B, and the SeNB C may have M, SA, SB, and SC connections by radio under control of the macro base station MeNB. In this case, the traffic may be performed through L3 control between the macro base station MeNB and the UE 10.

In detail, referring to FIG. 5, unlike an S1-U bearer S1-U RB according to the related art is mapped to a wireless bearer of the macro base station MeNB (that is, MeNB connection RB, referred to as “M conn. RB”) 1:1, the macro base station MeNB integrally managing heterogeneous small base stations SeNB A, SeNB B, and SeNB C additionally connects S1-U RB to SA RB, SB RB, and SC RB in parallel according to a wireless situation of a data path provided from another small base station.

A Radio bearer (RB) is a bearer provided from Uu interface in order to support a service of a user. Each interface defines a bearer to ensure independence between interfaces.

Bearers provided from the wireless communication system generally refer to an evolved packet system (EPS) bearer. The EPS bearer is divided into an RB, an S1-U bearer, and an S5/S8 bearer by interfaces.

The Packet Gateway (P-GW) is a network node to connect an LTE network to other networks. The EPS bearer is defined between the UE and the P-GW. The EPS bearer is further subdivided between respective nodes so that the RB is defined between the UE and the base station, an S1-U is defined between the base station and the S-GW, and an S5/S8 is defined between S-GW and P-GW inside an EPC.

An S1-U RB of a macro base station MeNB supporting a framework like the above operation structure (a, b) is connected to a M conn. RB and may be multiply mapped and connected to SA RB, SB RB, and SC RB. In other words, unlike the S1-U RB according to the related art mapped to only M conn. RB, the S1-U RB may be additionally connected to SA RB, SB RB, and SC RB in parallel as well as the M conn. RB according to a wireless situation.

For example, as in the operation structure (a) of FIG. 2, the macro base station MeNB is connected to small base stations SeNB A, SeNB B, and SeNB C in coverage of the macro base station MeNB through backhaul interface. The traffic path of the small base station SeNB may have a bearer connection scheme as illustrated in FIG. 6 in a direction connection structure with the GW. In detail, when an E-RAB of the E-RAB bearer includes E-RAB 0 and E-RAB 1 and the E-RAB 0 is on default, the E-RAB 0 is connected to Data /Radio Bearer 1(DRB 1) being M conn. RB through a GTP (GPRS Tunneling Protocol) 110 of the macro base station MeNB. The E-RAB 0 is connected to a MAC (Medium Access Control 140 through a PDCP (Packet Data Convergence Protocol) 120 and a RLC (Radio Link Control 130 and is scheduled through a MAC 140, and is connected to the UE through a PHY (physical layer) 150. Accordingly, the UE is connected to an upper GW through a layer of the macro base station MeNB. Meanwhile, in an additional small base station, for example, an E-RAB bearer is an E-RAB 1 for connection configuration with the small base station SeNB A, the E-RAB 1 is connected to a Data Radio Bearer 2 (DRB 2) being SA RB through a GTP 210 of the small base station SeNB A. The E-RAB 1 is connected to a MAC 240 through a PDCP 220 and a RLC 230 and is scheduled through a MAC 240, and is connected to the UE through a PHY 250. Accordingly, the UE is connected to an upper GW through a layer of the small base station SeNB A.

As another example, as in the operation structure (b) of FIG. 3, the macro base station MeNB is connected to small base stations SeNB A, SeNB B, and SeNB C in coverage of the macro base station MeNB through backhaul interface. The traffic path of the small base station SeNB may have a bearer connection scheme as illustrated in FIG. 7 and FIG. 8 in an indirection connection structure with the GW through the macro base station MeNB.

In the first scheme, as illustrated in FIG. 7, an E-RAB of an E-RAB bearer include an E-RAB 0 and an E-RAB 1 and the E-RAB 0 is on the default, the E-RAB 0 is connected to a Data Radio Bearer 1 (DRB 1) being M conn. RB and is scheduled through a MAC 140, and is connected to the UE through a PHY 150. Meanwhile, in an additional small base station, for example, an E-RAB bearer is an E-RAB 1 for connection configuration with the small base station SeNB A, the E-RAB 1 is connected to a logical Data Radio Bearer 2 (DRB 2) being SA RB through a GTP 110-2 of the macro base station MeNB and is then connected to a RLC 230, a MAC 240, and a PHY 250 of the small base station SeNB A through a PDCP 120-2 and a Xn-U. That is, the E-RAB 1 is connected to a SA RB of the small base station SeNB A. In this way, the E-RAB 1 is not connected through a bearer of a macro base station MeNB but not by radio but is connected to the small base station SeNB A. As in the case of the E-RAB 0, the E-RAB 1 may be connected to the macro base station MeNB but one bearer may not be simultaneously connected to the macro base station MeNB and the small base station SeNB A.

In the second scheme, as illustrated in FIG. 8, an E-RAB of an E-RAB bearer include an E-RAB 0 and an E-RAB 1 and the E-RAB 0 is on the default, the E-RAB 0 is connected to a Data Radio Bearer 1 (DRB 1) being M conn. RB and is scheduled through a MAC 140, and is connected to the UE through a PHY 150. Meanwhile, in an additional small base station, for example, an E-RAB bearer is an E-RAB 1 for connection configuration with the small base station SeNB A, the E-RAB 1 is connected to a logical Data Radio Bearer 2 (DRB 2) being SA RB through a GTP 110-2 of the macro base station MeNB and is connected to a PDCP 120-2, a RLC 130-2, a MAC 140, and a PHY 150 and is then connected to a RLC 230, a MAC 240, and a PHY 250 of the small base station SeNB A through a PDCP 120-2 and a Xn-U. That is, the E-RAB 1 is connected to a SA RB of the small base station SeNB A and a SA RB of the small base station SeNB A. In this way, the E-RAB 1 is simultaneously connected to the macro base station MeNB and the small base station SeNB A.

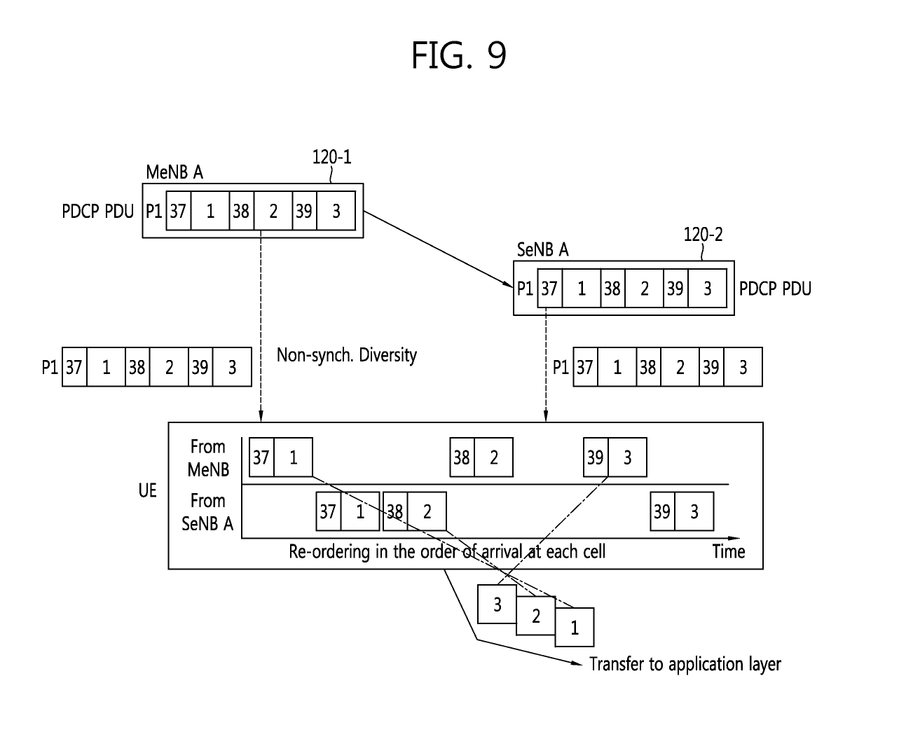

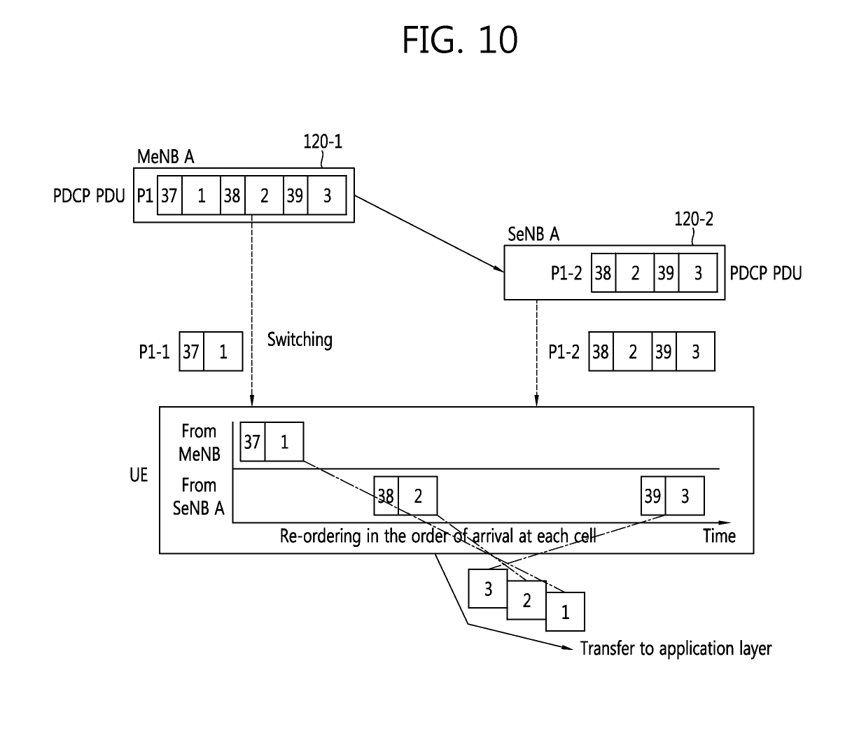

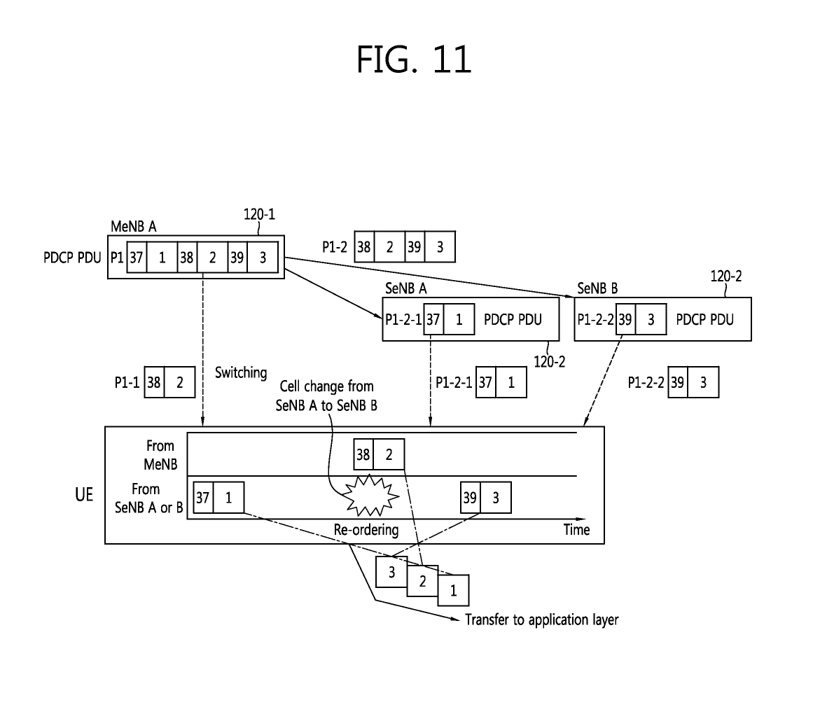

FIG. 9 is a diagram illustrating an example of transmitting a downlink packet according to an embodiment of the present invention. FIG. 10 is a diagram illustrating another example of transmitting a downlink packet according to an embodiment of the present invention. FIG. 11 is a diagram illustrating another example of transmitting a downlink packet according to an embodiment of the present invention. It is assumed that FIG. 9 to FIG. 11 has an operation structure (b) of FIG. 3 and sends a downlink packet in bearer connection scheme of FIG. 8.

Referring to FIG. 8 and FIG. 9, a packet P1 simultaneously transferred through a PDCP 120, that is, 120-1 and 120-2 of the macro base station MeNB is repeatedly transferred through a M conn. Of the macro base station MeNB and M conn. RB a SA RB of the small base station SeNB A. In this way, the same packet P1 is repeatedly transferred, the UE checks a PDCP SN of a packet P1 transferred from the macro cell and the small cell. Further, the UE performs ordering of PDCP PDU packets in a specific window to transfer the packet P1 to an application layer and removes a repeated packet. Such a packet transmission scheme may increase stability of packet transmission in that it repeatedly and simultaneously transfers the same packet P1 through a bearer of the macro base station MeNB and the small base station SeNB A. However, in an explosion situation of traffic, a wireless resource may be consumed.

As another example, referring to FIG. 8 and FIG. 10, in a state that two bearers of the macro base station MeNB and the small base station SeNB A for transmitting the packet P1, after the packet P1 is divided not to overlap, the packet is transferred through a bearer having the most excellent quality at a corresponding time point when the packet is transferred. For example, the packet P1 transferred through a PDCP 120, that is, 120-1 and 120-2 of the macro base station MeNB is divided into the packet P1-1 and the packet P1-2 not to overlap. In this case, it is assumed that a data amount of the packet P1-2 is greater than that of the packet P1-1 and a channel quality of the small base station SeNB A is better. The macro base station MeNB transfers the packet P1-1 to the UE through a M conn. RB. The macro base station MeNB transfers a packet P1-2 to a small base station SeNB A having more excellent channel quality so that the packet P1-2 is transferred to the UE through a SA RB. Accordingly, the UE reorders the packet P1-1 and the packet P1-2 transferred from the macro base station MeNB and the small base station SeNB A to transfer the reordered packets to an application layer.

As another example, packet transmission will be described when the small base station SeNB is changed according to movement of the UE with reference to FIG. 8 and FIG. 11. FIG. 11 will be illustrated on the assumption that the UE is moved to coverage of the small base station SeNB B from the small base station SeNB A in a state that two bearers of the macro base station MeNB and the small base station SeNB A for transmitting the packet P1 are configured. The packet P1 transferred through a PDCP 120, that is, 120-1 and 120-2 of the macro base station MeNB is divided into a packet P1-1) and a packet P1-2 by taking into consideration movement and redundancy of the UE. The macro base station transfer the packet P1-1 to the UE through the M conn. RB. The macro base station MeNB transfers the packet P1-2 to the small base station SeNB A so that the packet P1-2 is transferred to the UE through an SA RB. After a part P1-2-1 of the packet P1-2 is transferred through the small base station SeNB A, if the UE moves to coverage of the small base station SeNB B to change the small cell from the small base station SeNB A to the small base station SeNB B, in order to prevent packet loss and packet interruption upon cell change, a remaining one P1-2-2 of the packet P1-2 is transferred to the macro base station MeNB. After finally terminating cell change from the small base station SeNB A to the small base station SeNB B, the macro base station MeNB transfers a remaining one P1-2-2 of the packet P1-2 to the small base station SeNB B so that the remaining one P1-2-2 of the packet P1-2 is transferred to the UE through a SB RB. Accordingly, the UE reorder the packet P1-1 and the packet P1-2, that is, P1-2-1 and P1-2-2 transferred from the macro base station MeNB and small base stations SeNB A and SeNB B to transfer the reordered packets to the application layer.

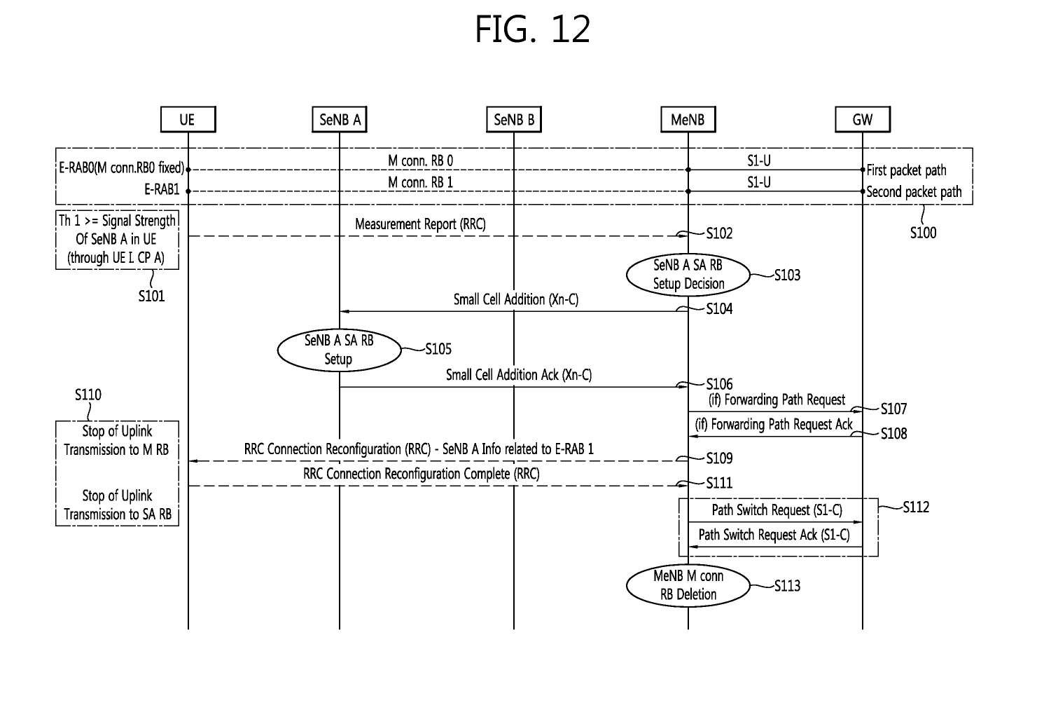

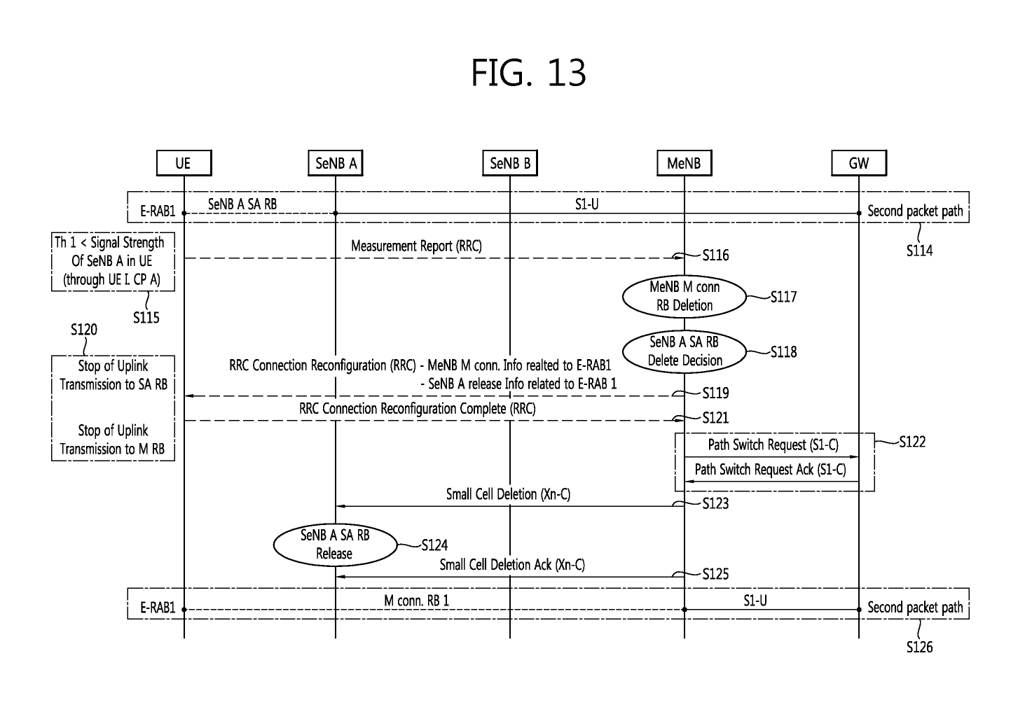

FIGS. 12 and 13 are flowcharts illustrating examples of a small cell operation process according to an embodiment of the present invention, respectively. FIG. 12 and FIG. 13 are illustrated based on a structure and a concept with respect to a MeNB driven Small Cell Operation under macro-driven illustrated in FIG. 2, FIG. 4, and FIG. 6, a direct Connection between a SeNB and a GW over traffic path and E-RAB 1 Change: MeNB->SeNB A->MeNB. In this case, it is assumed that the E-RAB 0 is always connected to a MeNB. A E-RAB 1 change signifies a process which switches E-RAB 1 from MeNB to SeNB and returns.

Referring to FIG. 12 and FIG. 13, the macro base station MeNB and a GW are configured to be connected to E-RAB 0 and E-RAB 1 through M conn. RB 0 and M conn. RB 1, respectively (S100). That is, a first packet path formed with “GW-(S1-U)-macro base station MeNB-M conn. RB 0-UE” is configured in the E-RAB 0. A second packet path formed with “GW-(S1-U)-macro base station MeNB-M conn. RB 1-UE” is configured in the E-RAB 1. In this case, it is assumed that a downlink reception tunnel ID to a macro base station MeNB of a S1-U interval of the E-RAB 1 is TE-ID X, and is a uplink reception tunnel ID TE-ID Y to the GW.

The UE determines whether signal strength of the small base station SeNB A in the UE is equal to or greater than an optional measurement reference value Th1 (S101). When the signal strength of the small base station SeNB A in the UE is equal to or greater than an optional measurement reference value Th1, the UE transfers a Measurement Report (hereinafter, compatibly used with “measurement report”) to the macro base station MeNB through an RRC message (S102).

The macro base station MeNB receives the Measurement Report from the UE. When the Measurement Report includes contents reporting that the signal strength of the small base station SeNB A collected from UE.I.CP (see FIG. 4) is equal to or greater than an optional measurement reference value Th1, the macro base station MeNB determines whether to add the small base station SeNB A to a second packet path formed through the E-RAB 1 (S103). When it is determined that the small base station SeNB A is added to the E-RAB 1, the macro base station MeNB transfers a Small cell Addition message (hereinafter, compatibly used with “small cell addition message”) through an Xn-C (S104).

The small base station SeNB A receives a Small cell Addition message from the macro base station MeNB. The small base station SeNB A configures a SA RB of the small base station SeNB A in an E-RAB 1 through an Xn-C (S105). After terminating the configuration, the small base station SeNB A transfers a Small cell Addition ACK message (hereinafter, compatibly used with “small cell addition message”) to the macro base station MeNB (S106). In this case, the Small cell Addition ACK includes a SeNB A reception downlink tunnel ID for a case of being downlinked to the small base station SeNB A in a GW. In this case, it is assumed that a SeNB A reception downlink tunnel ID is a TE-ID Z.

The macro base station transfers a Forwarding path request message including a SeNB A reception downlink tunnel ID transferred from the small base station SeNB A to the GW (S107). The GW transfers a Forwarding path request ACK message to the macro base station MeNB (S108). In this case, the Forwarding path request ACK message includes a MeNB forwarding data reception tunnel ID for transferring a downlink packet to the macro base station MeNB to the small base station SeNB through the GW. In this case, it is assumed that the MeNB forwarding data reception tunnel ID is a TE-ID T.

The macro base station MeNB transfers a RRC Connection Reconfiguration (hereinafter, compatibly used with “RRC connection reconfiguration message”) including SeNB A configuration information to be connected to the E-RAB 1 through an RRC message to the UE (S109). In this case, the macro base station MeNB may forward an E-RAB 1 downlink packet to the small base station SeNB A through the GW if necessary. That is, the downlink packet transferred to the macro base station MeNB in the GW is tagged to TE-ID T and is again transferred to the GW as uplink. The GW is again tagged to the TE-ID Z so that a packet is transferred to the small base station SeNB A.

The UE stops uplink packet transmission through M conn. RB of the macro base station MeNB, and starts uplink packet transmission through a SA RB of the small base station SeNB A (S110). The UE transfers a RRC Connection Reconfiguration Complete (hereinafter, compatibly used with “RRC reconfiguration termination message”) to the macro base station MeNB, and transmits the uplink packet to the small base station SeNB A (S111).

The macro base station MeNB transfers a Path Switch Request (S1-C) message to the GW. The macro base station MeNB changes a S1-U of a E-RAB 1 from “GW-macro base station MeNB” to “GW-small base station SeNB A” through a S1-C message processing which receives the Path Switch Request ACK (S1-C) from the GW (S112). The macro base station MeNB deletes M conn. RB information on the E-RAB 1 (S113).

If the above process is performed, the second packet path is changed from “GW-(S1-U)-(MeNB)-UE” to “GW-(S1-U)-(SeNB A)-UE” (S114). In this case, the small base station SeNB A receives a packet tagged to the TE-ID Z from the GW and tags a packet to be uplinked with the GW to the TE-ID Y. The downlink packet tagged to the TE-ID Z to be transferred may be two packets including a packet forwarded to the macro base station MeNB and a packet directly transferred to the GW without being forwarded to the macro base station MeNB. In this way, the following is a process where a second packet path according to the E-RAB 1 is again switched to “GW-(S1-U)-macro base station MeNB-UE” of before change as illustrated in step S100 while being changed to “GW-(S1-U)-small base station SeNB A-UE”.

The UE determines whether the signal strength of the small base station SeNB A in the UE is less than the optional measurement reference value Th1 (S115). When the signal strength of the small base station SeNB A in the UE is less than the optional measurement reference value Th1, the UE transfers a Measurement Report to the macro base station MeNB through an RRC message (S116).

The macro base station MeNB receives the Measurement Report from the UE. If the Measurement Report includes contents reporting whether the signal strength of the small base station SeNB A in the UE is less than the optional measurement reference value Th1 collected from the UE.I.CP (see FIG. 4) collected by the UE, the macro base station MeNB internally configures a M conn. RB 1 of the macro base station MeNB in the E-RAB 1 (S117). The macro base station MeNB determines a TE-ID U with respect to a downlink packet received from the GW while configuring the E-RAB 1 of the small base station SeNB A by radio. Moreover, the macro base station MeNB determines to delete the small base station SeNB A from the E-RAB 1 (S118).

The macro base station MeNB transfers RRC Connection Reconfiguration including a command for requesting to remove a SA RB of the small base station SeNB A through the RRC message and a command for requesting to configure a M conn. RB of the macro base station MeNB to the E-RAB 1 (S119).

The UE stops uplink packet transmission through a SA RB of the small base station SeNB A, and starts the uplink packet transmission through an M conn. RB (S120). The UE transfers a RRC Connection Reconfiguration Complete to the macro base station MeNB through the RRC message (S121). In this case, when there is a uplink packet to be transmitted, the UE transmits the uplink packet through the M conn. RB.

The macro base station MeNB transfers a Path Switch Request(S1-C) message to the GW. The macro base station MeNB reports that a second packet path with respect to the E-RAB 1 is changed from “GW-(S1-U)-small base station SeNB A-UE” to “GW-(S1-U)-macro base station MeNB-UE” to the GW during processing of the S1-C message which receives from a Path Switch Request ACK(S1-C) from the GW (S122). The macro base station MeNB transfers a Small cell Deletion message to the small base station SeNB A through a Xn-C so that SA RB relation configuration information of the small base station SeNB A may be all deleted from the E-RAB 1 (S123).

The small base station SeNB A receives the Small cell Deletion message from the macro base station MeNB. The small base station SeNB A removes all the SA RB relation configuration information of the small base station SeNB A from the E-RAB 1 (S124). After terminating the deletion, the small base station SeNB A transfers the Small cell Deletion ACK message to the macro base station MeNB through an Xn-C (S125).

If step S125 is performed, the second packet path is changed to “GW-(S1-U)-macro base station MeNB-UE” as firstly configured in step S100 from “GW-(S1-U)-small base station SeNB A-UE” (S126). In other words, a path of “M conn. RB-macro base station MeNB B-GW”.

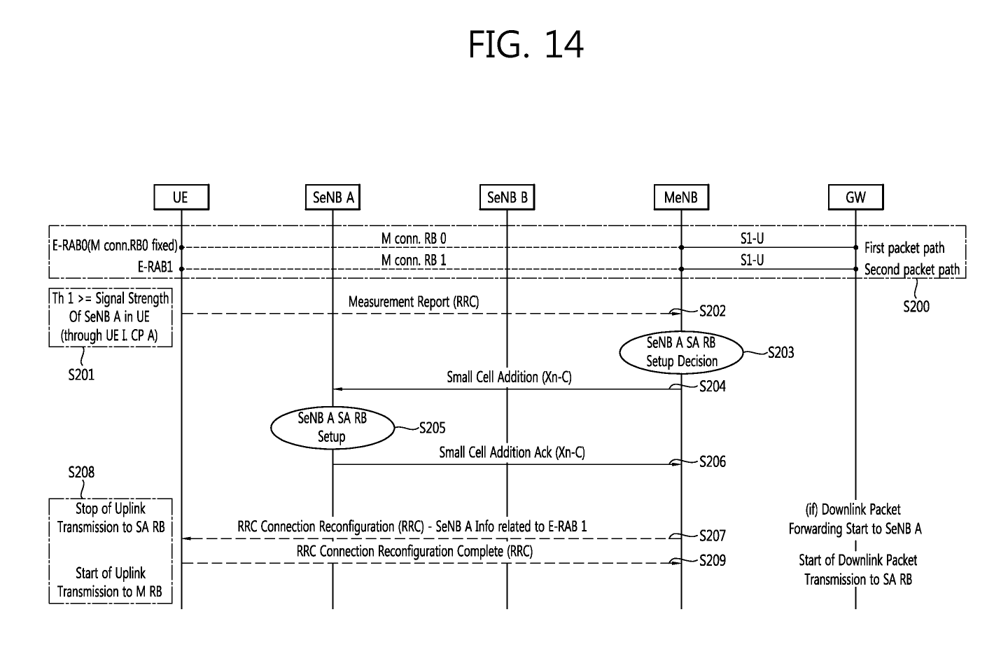

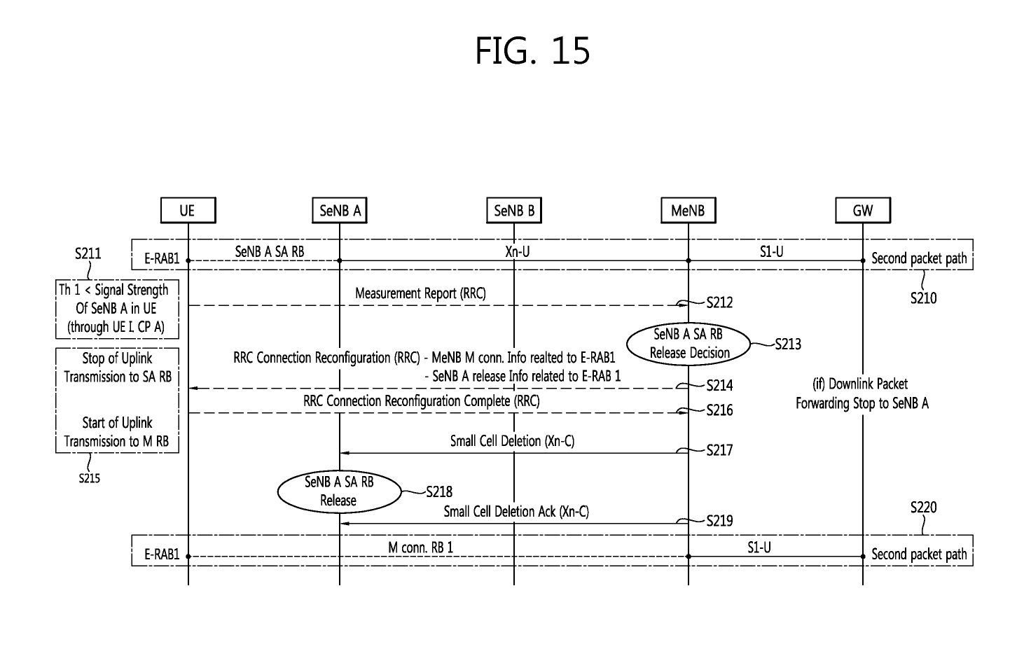

FIGS. 14 and 15 are flowcharts illustrating other examples of a small cell operation process according to an embodiment of the present invention, respectively. FIG. 14 and FIG. 15 are illustrated based on a structure and a concept with respect to a MeNB driven Small Cell Operation under macro-driven as illustrated in FIG. 3, FIG. 4, and FIG. 7, in-direct Connection between a SeNB and a GW over traffic path and E-RAB 1 Change: MeNB->SeNB A->MeNB. In this case, it is assumed that the E-RAB 0 is always connected to a MeNB. A E-RAB 1 change signifies a process which switches E-RAB 1 from MeNB to SeNB and returns.

Referring to FIG. 14 and FIG. 15, the UE and the macro base station MeNB are configured to be connected to E-RAB 0 and E-RAB 1 through M conn. RB 0 and M conn. RB 1, respectively (S200). That is, a first packet path formed with “GW-(S1-U)-macro base station MeNB-M conn. RB 0-UE” is configured in the E-RAB 0. A second packet path formed with “GW-(S1-U)-macro base station MeNB-M conn. RB 1-UE” is configured in the E-RAB 1.

The UE determines whether signal strength of the small base station SeNB A in the UE is equal to or greater than an optional measurement reference value Th1 (S201). When the signal strength of the small base station SeNB A in the UE is equal to or greater than an optional measurement reference value Th1, the UE transfers a Measurement Report to the macro base station MeNB through an RRC message (S202).

The macro base station MeNB receives the Measurement Report from the UE. When the Measurement Report includes contents reporting that the signal strength of the small base station SeNB A collected from UE.I.CP (see FIG. 4) is equal to or greater than an optional measurement reference value Th1, the macro base station MeNB determines whether to add the small base station SeNB A to a second packet path formed through the E-RAB 1 (S203). When it is determined that the small base station SeNB A is added to the E-RAB 1, the macro base station MeNB transfers a Small cell Addition message through an Xn-C (S204).

The small base station SeNB A receives a Small cell Addition message from the macro base station MeNB. The small base station SeNB A configures a SA RB of the small base station SeNB A in an E-RAB 1 through an Xn-C (S205). In this time, a Xn-U traffic path with respect to the E-RAB 1 is generated, and a bearer of the macro base station is connected to a bearer of a small base station through the Xn-U traffic path. In this case, connection of a M conn. RB of the macro base station MeNB is released from the E-RAB 1. After terminating the configuration, the small base station SeNB A transfers a Small cell Addition ACK message to the macro base station MeNB (S206).

The macro base station transfers a RRC Connection Reconfiguration including SeNB A configuration information to be added to the E-RAB 1 the UE through the RRC message (S207). In this case, the macro base station MeNB may forward a download packet to be transferred through the E-RAB 1 to the SeNB A through the Xn-U.

The UE stops uplink packet transmission through the M conn. RB of the macro base station MeNB (S208). The UE transfers a RRC Connection Reconfiguration Complete to the macro base station MeNB through a RRC message, and transmits an uplink packet to a small base station SeNB A (S209).

Accordingly, the macro base station MeNB changes a S1-U of the E-RAB 1 from “GW-macro base station MeNB[-UE)]” to “GW-macro base station MeNB[-small base station SeNB A-UE]”. If the above step is performed, a second packet path of the E-RAB 1 is changed from “GW-(S1-U)-macro base station MeNB-UE” to “GW-(S1-U)-macro base station MeNB-small base station SeNB A-UE)” (S210).

In this way, the following is a process where a second packet path according to the E-RAB 1 is again switched to “GW-(S1-U)-macro base station MeNB-UE” of before change as illustrated in step S200 while being changed to “GW-(S1-U)-macro base station MeNB-UE”.

The UE determines whether signal strength of the small base station SeNB A in the UE is less than an optional measurement reference value Th1 (S211). When the signal strength of the small base station SeNB A in the UE is less than an optional measurement reference value Th1, the UE transfers a Measurement Report to the macro base station MeNB through the RRC message (S212).

The macro base station MeNB receivers the Measurement Report from the UE. When the Measurement Report includes contents reporting that the signal strength of the small base station SeNB A collected from UE.I.CP (see FIG. 4) is less than an optional measurement reference value Th1, the macro base station MeNB determines whether to release the SA RB of the small base station SeNB A from the E-RAB 1 (S213). In this case, the macro base station MeNB internally configures connection of the M conn. RB 1 in the E-RAB 1.

The macro base station MeNB transfers RRC Connection Reconfiguration including a command for requesting to delete all information of the small base station SeNB A (SA RB and network) connected to the E-RAB 1 through the RRC message to the UE (S214).

The UE stops uplink packet transmission through the SA RB of the small base station SeNB A, and starts the uplink packet transmission through a M conn. RB of the macro base station MeNB (S215). The UE transfers a RRC Connection Reconfiguration Complete to the macro base station MeNB through the RRC message (S216).

The macro base station MeNB transfers a Small cell Deletion message to the small base station SeNB A through a Xn-C so that SA RB relation configuration information of the small base station SeNB A may be all deleted from the E-RAB 1 (S217). In this case, there is an uplink packet to be transmitted, the UE transmits the uplink packet through the M conn. RB.

The small base station SeNB A receives the Small cell Deletion message from the macro base station MeNB. The small base station SeNB A deletes all SA RB configuration relation information of the small base station SeNB A from the E-RAB 1 (S218). After terminating the deletion, the small base station SeNB A transfers the Small cell Deletion ACK message to the macro base station MeNB through an Xn-C (S219).

If step S219 is performed, the second packet path is changed to “GW-(S1-U)-macro base station MeNB -UE” as firstly configured in step S200 from “GW-(S1-U)-small base station SeNB A-UE” (S220).

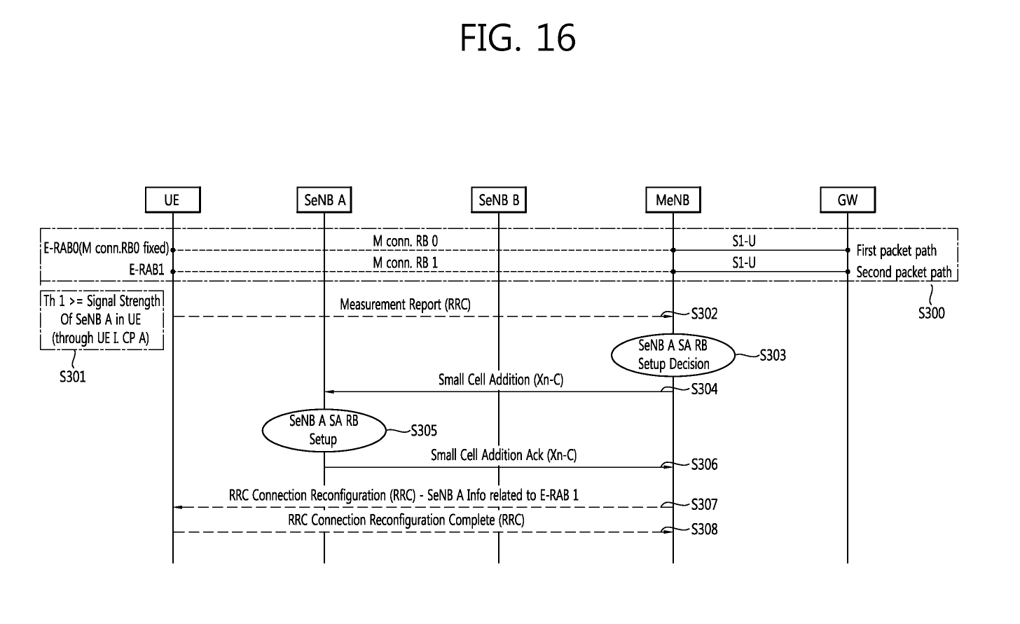

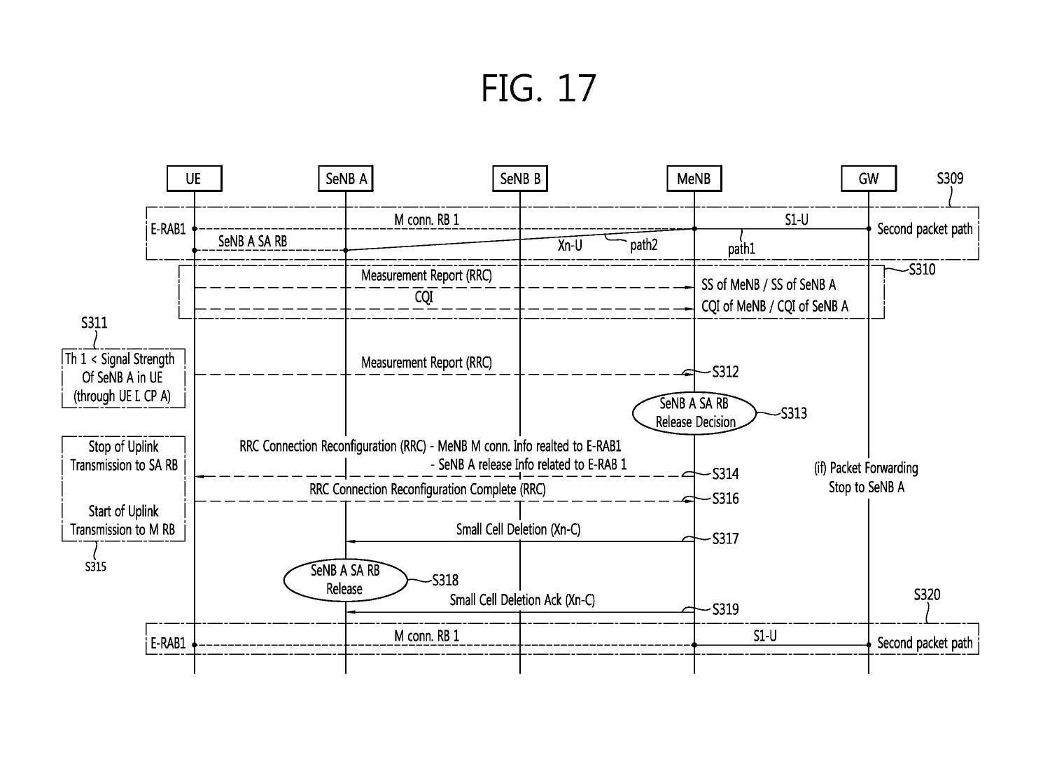

FIGS. 16 and 17 are flowcharts illustrating other examples of a small cell operation process according to an embodiment of the present invention, respectively. FIG. 16 and FIG. 17 are illustrated based on a structure and a concept with respect to a MeNB driven Small Cell Operation under macro-driven as illustrated in FIG. 3, FIG. 4, and FIG. 8, in-direct Connection between a SeNB and a GW over traffic path and E-RAB 1 Change: MeNB->MeNB & SeNB A(Bearer Split)->MeNB. In this case, it is assumed that the E-RAB 0 is always connected to a MeNB. A E-RAB 1 change signifies a process which switches E-RAB 1 from MeNB to SeNB and returns.

Referring to FIG. 16 and FIG. 17, the EU and the macro base station MeNB are configured to be connected to the E-RAB 0 and the E-RAB 1 through the M conn. RB 0 and M conn. RB 1, respectively (S300). That is, a first packet path formed with “GW-(S1-U)-macro base station MeNB-M conn. RB 0-UE” is configured in the E-RAB 0. A second packet path formed with “GW-(S1-U)-macro base station MeNB-M conn. RB 1-UE” is configured in the E-RAB 1.

The UE determines whether signal strength of the small base station SeNB A in the UE is equal to or greater than an optional measurement reference value Th1 (S301). When the signal strength of the small base station SeNB A in the UE is equal to or greater than an optional measurement reference value Th1, the UE transfers a Measurement Report to the macro base station MeNB through an RRC message (S302).

The macro base station MeNB receives a Measurement Report from the UE. When the Measurement Report includes contents reporting that the signal strength of the small base station SeNB A collected from UE.I.CP (see FIG. 4) is equal to or greater than an optional measurement reference value Th1, the macro base station MeNB determines whether to add the small base station SeNB A to a second packet path formed through the E-RAB 1 (S303). When it is determined that the small base station SeNB A is added to the E-RAB 1, the macro base station MeNB transfers a Small cell Addition message through an Xn-C (304).

The small base station SeNB A receives a Small cell Addition message from the macro base station MeNB. The small base station SeNB A configures a SA RB of the small base station SeNB A in an E-RAB 1 through an Xn-C (S305). In this time, an Xn-U traffic path with respect to the E-RAB 1 is generated. A bearer of the macro base station is connected to a bearer of the small base station through the Xn-U traffic path. In this case, connection of the M conn. RB of the macro base station maintains without release. After terminating the configuration, the small base station SeNB A transfers a Small cell Addition ACK message to the macro base station MeNB (S306).

The macro base station transfers a RRC Connection Reconfiguration including SeNB A configuration information to be added to the E-RAB 1 to the UE through the RRC message (S307).

The UE terminates configuration of the SA RB for transmission uplink packet to the small base station SeNB A. The UE transfers a RRC Connection Reconfiguration Complete to the macro base station MeNB through the RRC message (S308).

The macro base station MeNB ensures a double path by adding “GW-macro base station MeNB-small base station SeNB A-UE as well as “GW-macro base station MeNB-UE” in the “GW-macro base station MeNB-UE” to the S1-U of the E-RAB 1 (S309). That is, if step S309 is performed, a “GW-(S1-U)-macro base station (MeNB)-small base station SeNB A-UE”(path 2) as well as “GW-(S1-U)-macro base station (MeNB)-UE)”(path 1) firstly configured in step S300 are included in the second packet path of the E-RAB 1 configured in step S300.

In this way, if a double path is ensured, as shown in FIG. 9, all packets are transmitted to uplink or downlink through the path 1 and the path 2 at a PDCP of the macro base station MeNB. Accordingly, a PDCP of the UE receiving all the packets checks a PDCP SN in a specific window and transfers the reordered packet to an application packet to removes a repeated packet. In a case of the macro base station MeNB, the received packet may be transferred to the GW.

Further, if the double path is ensured, as shown in FIG. 10, the packet may be transmitted by selecting a path with excellent channel quality. For example, if signal strength of the macro base station MeNB and signal strength of the small base station SeNB A are reported from a Measurement Report transferred from the UE through the RRC message, the macro base station MeNB may select the most excellent channel quality based on the signal strength to transmit the packet. Alternatively, the macro base station MeNB may receive a CQI of the macro base station MeNB and a CQI of the small base station SeNB A from an MAC stage of the macro base station MeNB to rapidly select a channel path (S310).

In this way, the following is a process where a second packet path according to the E-RAB 1 is again switched to “GW-(S1-U)-macro base station MeNB A-UE” (path 2) of before change by deleting path 2 as illustrated in step S300 while adding the path 2 as well as “GW-(S1-U)-macro base station MeNB-UE” (path 1).

The UE determines whether signal strength of the small base station SeNB A in the UE is less than an optional measurement reference value Th1 (S311). When the signal strength of the small base station SeNB A in the UE is less than an optional measurement reference value Th1, the UE transfers a Measurement Report to the macro base station MeNB through the RRC message (S312).

The macro base station MeNB receives a Measurement Report from the UE. When the Measurement Report includes contents reporting that the signal strength of the small base station SeNB A collected from UE.I.CP (see FIG. 4) is less than an optional measurement reference value Th1, the macro base station MeNB determines whether to release the SA RB of the small base station SeNB A from the E-RAB 1 (S313).

The macro base station MeNB transfers RRC Connection Reconfiguration including a command for requesting to delete all information of the small base station SeNB A (SA RB and network) connected to the E-RAB 1 through the RRC message to the UE (S314).

The UE stops uplink packet transmission through the SA RB of the small base station SeNB A, and starts the uplink packet transmission through a M conn. RB of the macro base station MeNB (S315). The UE transfers a RRC Connection Reconfiguration Complete to the macro base station MeNB through the RRC message (S316). In this case, if there is an uplink packet to be transmitted, the UE transmits an uplink packet through a M conn. RB.

The macro base station MeNB transfers a Small cell Deletion message to the small base station SeNB A through a Xn-C so that “SW-(S1-U)-small base station SeNB A-UE” (path 2) may be deleted by deleting all SA RB configuration relation information of the small base station SeNB A from the E-RAB 1 (S317). That is, the macro base station MeNB deletes an SA RB of the small base station SeNB A with respect to the E-RAB 1 through the Xn-C, and deletes a path between the MeNB and the SeNB from the macro base station MeNB.

The small base station SeNB A receives a Small cell Deletion message from the macro base station MeNB. The small base station SeNB A deletes all SA RB configuration relation information of the small base station SeNB A from the E-RAB 1 (S318). After terminating the deletion, the small base station SeNB A transfers the Small cell Deletion ACK message to the macro base station MeNB through an Xn-C (S319).

If step S319 is performed, the second packet path is changed to maintain only a “GW-(S1-U)-macro base station MeNB-UE” (path 1) as firstly configured in step S300 while including the “GW-(S1-U)-macro base station MeNB-UE” (path 1) and a “GW-(S1-U)-macro base station MeNB-small base station SeNB A-UE” (path 2) (S320).

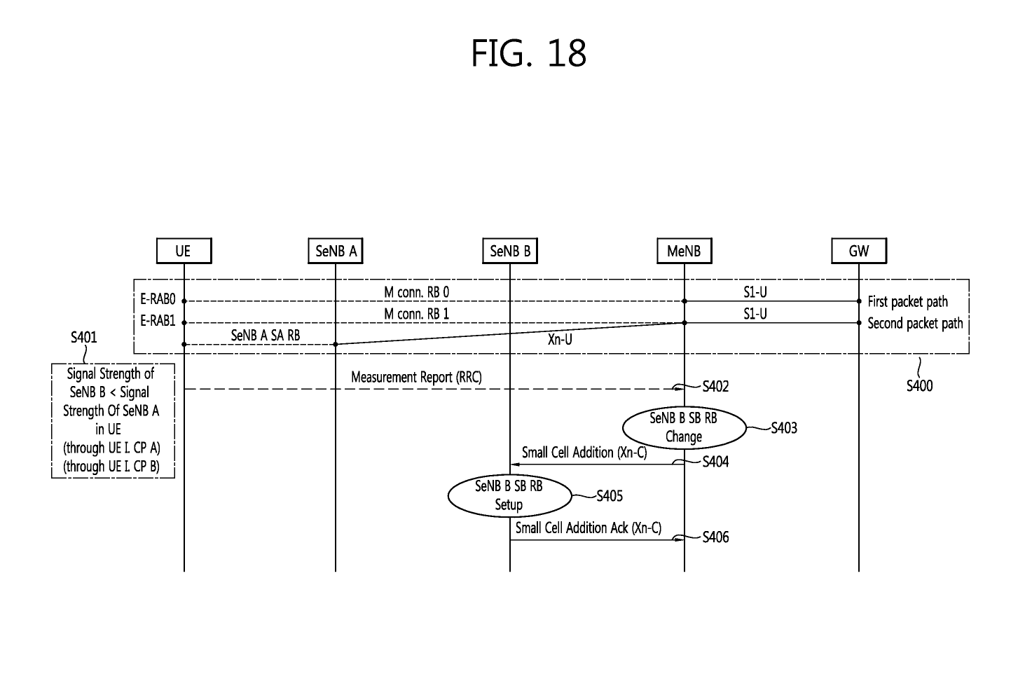

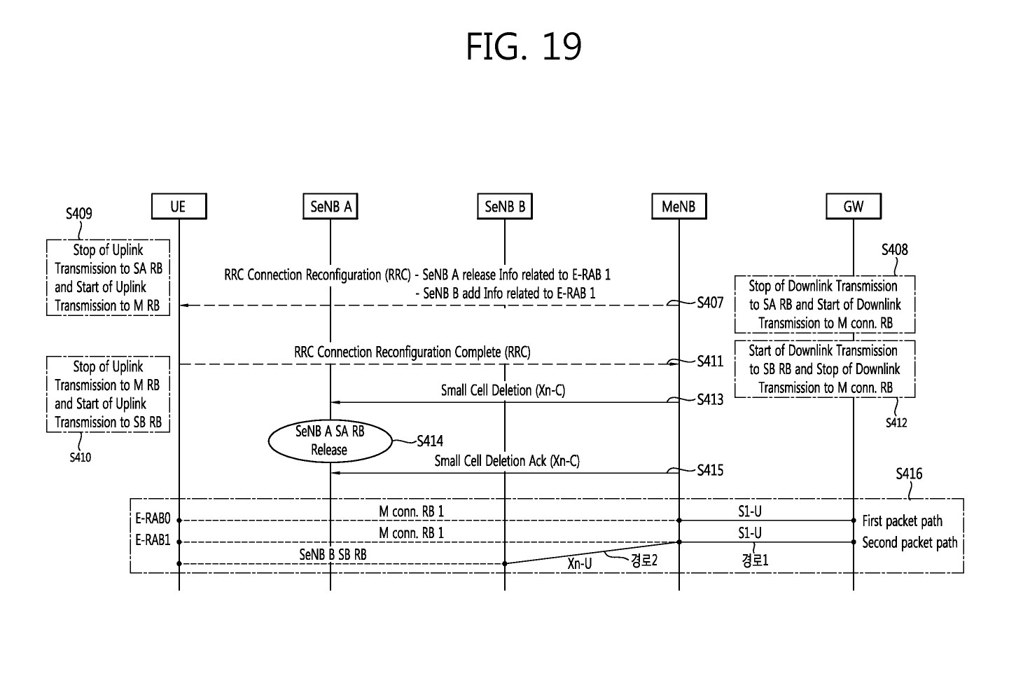

FIGS. 18 and 19 are flowcharts illustrating other examples of a small cell operation process according to an embodiment of the present invention, respectively. FIG. 18 and FIG. 19 illustrate a process operating FIG. 11 in a structure and a concept as illustrated in FIG. 3, FIG. 4, and FIG. 8, that is, based on a MeNB driven Small Cell Operation under macro-driven, in-direct Connection between a SeNB and a GW over traffic path and E-RAB 1??related Cell Change : MeNB&SeNB A▪MeNB&SeNB B( ).

Referring to FIG. 18 and FIG. 19, a first packet path formed of UE-macro base station MeNB-GW″ is configured in a E-RAB 0 between the UE and the macro base station MeNB. A second packet path operated in a state that a UE-small base station SeNB A-macro base station MeNB-GW″ (path 2) as well as UE-macro base station MeNB-GW″(path 1) are connected is configured in an E-RAB 1 (S400). The following describes a process where a path of a small base station with respect to the E-RAB 1 is moved to a path of a small base station SeNB B.

The UE determines whether signal strength of the small base station SeNB A in the UE is less than signal strength of the small base station SeNB B (S401). When the signal strength of the small base station SeNB A in the UE is less than the signal strength of the small base station SeNB B, the UE transfers a Measurement Report to the macro base station MeNB through an RRC message (S402). That is, the UE collects signal strength of the small base station SeNB A and signal strength of the small base station SeNB B from UE.I.CP A and UE.I.CP B to transfer measurement results through M access of the macro base station MeNB (see FIG. 4).

The macro base station MeNB receives a Measurement Report from the UE. If the Measurement Report includes contents to report whether the signal strength of the small base station SeNB A collected by the UE from the UE.I.CP A and the UE.I.CP B is less than the signal strength of the small base station SeNB B, the macro base station MeNB determines whether to change connection with the E-RAB 1 from the small base station SeNB A to the small base station SeNB B (S403). When it is determined to connect the small base station SeNB B to the E-RAB 1, the macro base station MeNB transfers a Small cell Addition message to the small base station SeNB B through a Xn-C (S404).

The small base station SeNB B receives Small cell Addition from the macro base station MeNB. The small base station SeNB B configures a SB RB of the small base station SeNB B in the E-RAB 1 through a Xn-C (S405). At this time, the small base station SeNB B prepares transmission/reception with the macro base station MeNB and similarly the macro base station MeNB prepares transmission/reception with the small base station SeNB B. After terminating the configuration, the small base station SeNB B transfers a Small cell Addition ACK message to the macro base station MeNB through the Xn-C (S406). In other words, the macro base station MeNB generates and transfers a reception tunnel ID to the small base station SeNB B, and the small base station SeNB B generates and transfers the reception tunnel ID to the macro base station MeNB to share a transmission/reception tunnel ID with each other.

The macro base station MeNB deletes all information (SA RB and network) of the small base station SeNB A connected to the E-RAB 1 through the RRC message and transfers RRC Connection Reconfiguration including a command to add the SB RB of the small base station SeNB B to the UE (S407). Simultaneously, if a downlink packet is transmitted to the small base station SeNB A, the macro base station MeNB stops transmission of the downlink packet and transmits the downlink packet through a M conn. RB of the macro base station MeNB (S408).

The UE deletes a SA RB of the small base station SeNB A and terminates configuration to add a SB RB of the small base station SeNB B. The UE stops transmission of the uplink packet through a SA RB of the small base station SeNB A, and starts transmission of the uplink packet through a M conn. RB of the macro base station MeNB (S409). In this case, if there is the uplink packet transmitted through the SA RB, the UE stops the transmission of the uplink packet and transfers the uplink packet to the M conn. RB. Next, the UE stops transmission of the uplink packet through the M conn. RB of the macro base station MeNB, and starts the transmission of the uplink packet through a SB RB of the small base station SeNB B (S410). If the addition of the SB RB of the small base station SeNB B is terminated, the UE transfers a RRC Connection Reconfiguration Complete to the macro base station MeNB through the RRC message (S411). In this case, the UE may transfer the uplink packet transmitted through the M conn. RB of the macro base station MeNB to the SB RB of the small base station SeNB B.

The macro base station MeNB receives a RRC Connection Reconfiguration Complete from the UE. If there is the downlink packet transferred through the M conn. RB of the macro base station MeNB, the macro base station MeNB stops transmission of the downlink packet through the M conn. RB, and starts transmission of the downlink packet through the SB RB of the small base station SeNB B (S412).

The macro base station MeNB transfers the Small cell Deletion message to the small base station SeNB A through the Xn-C so that all SA RB relation information of the small base station SeNB A may be deleted from the E-RAB 1 (S413).

The small base station SeNB A receives the Small cell Deletion message from the macro base station MeNB. The small base station SeNB A deletes SA RB configuration relation information on the small base station SeNB A and Xn-U information on the small base station SeNB A (S414). After terminating the deletion, the small base station SeNB A transfers the Small cell Deletion ACK message to the macro base station MeNB through the Xn-C (S415).

If the above process is performed, in the second packet path, “UE-macro base station MeNB-GW” (path 1) is the same but the path 2 is changed to “UE-small base station SeNB B-macro base station MeNB-GW” (S416). That is, in the second packet path of the E-RAB 1, a M conn. RB of the “macro base station MeNB-GW” is the same as M conn. RB of “UE)-macro base station MeNB” but an additional path 2 is changed from “UE-small base station SeNB A-macro base station MeNB-GW” to “UE-small base station SeNB B-macro base station MeNB-GW”.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for managing a resource in a small cell environment by a macro base station for controlling connection between user equipment (UE) and a gateway (GW), the method comprising:
configuring at least one packet path between the GW and the UE through a bearer of the macro base station;
determining whether to add at least one small base station in the macro base station to the at least one packet path according to signal strength of the at least one small base station from the UE; and
changing the at least one packet path using a bearer of a small base station based on the result.

2. The method of claim 1, wherein an E-RAB of an EPS bearer defined between the GW and the UE comprises an E-RAB 0 and an E-RAB 1, and, the configuring of the at least one packet path comprises:
configuring a first packet path by connecting a first bearer of the macro base station to the E-RAB 0; and
configuring a second packet path by connecting a second bearer of the macro base station to the E-RAB 1.

3. The method of claim 2, wherein the determining whether to add at least one small base station in the macro base station comprises:
determining whether to add the first small base station to the second packet path using signal strength of a first small base station among at least one small base station included in the macro base station; and
transferring a small cell addition message indicating that the first small base station is added to the second packet path.

4. The method of claim 3, wherein the changing of the at least one packet path comprises:
transferring configuration information of the first small base station to the UE;
receiving a RRC Connection Reconfiguration Complete message indicating that connection of a bearer of the first small base station is terminated instead of a second bearer of the macro base station in the E-RAB 1 from the UE; and
terminating change of the second packet path by requesting to change connection of a S1-U of the E-RAB 1 from the macro base station to the first small base station to the GW.

5. The method of claim 4, further comprising:
determining deletion of the bearer of the first small base station connected to the E-RAB 1 using the signal strength of the first small base station;
deleting the bearer of the first small base station connected to the E-RAB 1 and requesting to connect a second bearer of the macro base station to the UE; and
configuring the second packet path to before change by requesting to change the connection of the S1-U of the E-RAB 1 from the first small base station to the macro base station.

6. The method of claim 2, wherein determining whether to add at least one small base station comprises:
determining whether to add the first small base station to the second packet path using signal strength of a first small base station among at least one small base station included in a cell of the macro base station;
connecting the second bearer of the macro base station to the bearer of the first small base station through a Xn-U in order to configure the bearer of the first small base station in the E-RAB 1; and
releasing the connection of the second bearer of the macro base station from the E-RAB 1.

7. The method of claim 6, wherein the changing of the at least one packet path comprises: changing connection of the S1-U of the E-RAB 1 from the bearer of the macro base station to the bearer of the first small base station .

8. The method of claim 2, wherein the determining whether to add at least one small base station comprises:
determining whether to add the first small base station to the second packet path using signal strength of a first small base station among at least one small base station included in a cell of the macro base station;
connecting the second bearer of the small base station to the bearer of the first small base station through a Xn-U in order to configure the bearer of the first small base station in the E-RAB 1; and
maintaining connection of the second bearer of the macro base station to the E-RAB 1.

9. The method of claim 8, wherein the changing of the at least one packet path comprises: ensuring a double path by adding connection with the first small base station through a Xn-U in a state that connection of the second bearer of the macro base station in the S1-U of the E-RAB 1 maintains.

10. The method of claim 9, further comprising one of
simultaneously transmitting a same packet through the double path; and
selecting a path having excellent transmission quality from the double path to transmit a path through the selected path.

11. A method for managing a resource in a small cell environment by a macro base station for controlling connection between user equipment (UE) and a gateway (GW), the method comprising:
configuring at least one packet path by connecting the GW to the UE through a bearer of the macro base station;
additionally configuring connection of a first small base station among at least two small base stations in the at least one packet path;
determining whether change connection with the first small base station to connection of a second small base station based on a result of comparing signal strength of a second small base station to be replaced with the first small base station with signal strength of the first small base station; and
changing the at least one packet path by connecting the second small base station to the at least one packet path according to the determination.

12. The method of claim 11, wherein an E-RAB of an EPS bearer defined between the GW and the UE comprises an E-RAB 0 and an E-RAB 1, and,
the configuring of the at least one packet path comprises:
configuring a first packet path by connecting a first bearer of the macro base station to the E-RAB 0; and
configuring a second packet path by connecting a second bearer of the macro base station to the E-RAB 1.

13. The method of claim 12, wherein the determining whether change connection with the first small base station comprises:
receiving a result of comparing signal strength of the first small base station with signal strength of the second base station;
determining whether to changing the first small base station to the second small base station based on the comparison result; and
transferring a message indicating that the second small base station is added to the second packet path to the small base station.

14. The method of claim 13, wherein the changing the at least one packet path comprises:
deleting configuration information of the first small base station and transferring configuration information of the second small base station to the UE;
receiving a message indicating that connection of a bearer of the second small base station is terminated instead of a bearer of the small base station in the E-RAB 1 from the UE; and
transferring a deletion request message to the first small base station to delete bearer configuration information of the first small base station; and
receiving a deletion termination message from the first small base station.

15. The method of claim 14, wherein the changing the at least one packet path comprises: terminating change of the second packet path by connecting the second small base station instead of the first small base station in the second packet path.

16. A method for managing a resource in a small cell environment including at least one small base station included in a cell of a macro base station for controlling connection between user equipment (UE) and a gateway (GW), the method comprising:
configuring a first packet path by connecting a first bearer of the macro base station to an E-RAB 0 defined between the UE and the GW;
configuring a second packet path by connecting a second bearer of the macro base station to an E-RAB 1 defined between the UE and the GW;
requesting to connect the bearer of the first small base station to the E-RAB 1 in order to add a first small base station among the at least one small base station and
changing the second packet path by connecting the bearer of the first small base station to the E-RAB 1.

17. The method of claim 16, wherein the requesting to connect the bearer of the first small base station comprises:
transferring a Small cell Addition message to the first small base station through a Xn-C; and
receiving a Small cell Addition ACK message from the first small base station through the Xn-C when connection of the bearer of the first small base station to the E-RAB 1 is terminated.

18. The method of claim 16, wherein the requesting to connect the bearer of the first small base station comprises:
connecting the bearer of the first small base station to the E-RAB 1 through a Xn-C; and
generating the Xn-C to connect the macro base station to the first small base station.

19. The method of claim 18, wherein the changing the at least one packet path comprises: changing the second packet path by connecting the bearer of the first small base station including a RLC, a MAC, and a PHY through the a Xn-U after connecting the second bearer of the macro base station including a GTP and a PDCP to the E-RAB 1.

20. The method of claim 16, wherein the requesting of the configuration of the bearer comprises:
connecting the bearer of the first small base station to the E-RAB 1 through a Xn-C;
maintaining connection of the second bearer of the macro base station to the E-RAB 1; and
generating a Xn-U to connect the macro base station to the small base station.
